(19) United States
(12) Patent Application Publication
(10) Pub. No.: US 2014/0204056 A1
(43) Pub. Date: Jul. 24, 2014

(54) PARAMETER EXTRACTION SYSTEM FOR TOUCH PANEL AND PARAMETER EXTRACTION METHOD THEREOF

(71) Applicant: Samsung Electro-Mechanics Co., Ltd., Suwon-si (KR)

(72) Inventors: Kyung Hee Hong, Suwon-si (KR); Hyun Jun Kim, Suwon-si (KR); Tah Joon Park, Suwon-si (KR); Moon Suk Jeong, Suwon-si (KR); Byeong Hak Jo, Suwon-si (KR)

(73) Assignee: Samsung Electro-Mechanics Co., Ltd., Suwon-si (KR)

(21) Appl. No.: 14/142,670

(22) Filed: Dec. 27, 2013

(30) Foreign Application Priority Data
Jan. 24, 2013 (KR) 10-2013-0008240

(51) Int. Cl. G06F 3/044

(52) U.S. Cl. CPC G06F 3/044
USPC 345/174

(57) ABSTRACT

Disclosed herein is a parameter measuring method of a touch panel. The method measures S-parameters at cross points of electrodes of the touch panel, converts the measured S-parameters into Y-parameters, extracts all the equivalent parameters from the Y-parameters, and compensates for a loss value, thereby accurately providing electrical characteristics of the touch panel.

### CROSS REFERENCE TO RELATED APPLICATION

This application claims the benefit of Korean Patent Application No. 10-2013-0008240, filed on Jan. 24, 2013, entitled “Parameter Extraction System For Touch Panel And Parameter Extraction Method Thereof” which is hereby incorporated by reference in its entirety into this application.

### BACKGROUND OF THE INVENTION

1. Technical Field

The present invention relates to a parameter extraction system for a touch panel and a parameter extraction method thereof.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

In accordance with the rapid advancement of an information-oriented society, the use of computers has gradually been widened; however, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) and is used to allow a user to select desired information while viewing the image display device.

Meanwhile, the touch panel is classified into a resistive type touch panel, a capacitive type touch panel, an electromagnetic type touch panel, a surface acoustic wave (SAW) type touch panel, and an infrared type touch panel. These various types of touch to panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

The electrical characteristics of the touch panel have a great effect on the performance of the touch panel system. In particular, in a capacitive type touch panel, since a range of an input signal determines an operation range of an analog circuit, components, a size of an implementation circuit, a determination of a signal timing, and a calibration method of firmware, and the like, in a touch panel system are determined, it is very important to extract electrical equivalent parameters of the touch panel.

For this reason, as described in Chinese Patent Laid-Open Publication No. 102539950, researches into development of an apparatus of inspecting electrical characteristics of a capacitive type touch panel have been actively conducted. However, only the mutual capacitance and resistance component are extracted using the shift of the resonance frequency, which may not satisfy a method for accurately extracting all the equivalent parameters of the touch panel.

### RELATED ART DOCUMENT

### Patent Document

(Patent Document 1) Chinese Patent Laid-Open Publication No. 102539950

### SUMMARY OF THE INVENTION

The present invention has been made in an effort to provide a parameter extraction system for a touch panel capable of extracting all the equivalent parameters at cross points between electrodes of a touch panel.

Further, the present invention has been made in an effort to provide a parameter to extraction method for a touch panel capable of extracting all the equivalent parameters at cross points between electrodes of a touch panel.

According to a preferred embodiment of the present invention, there is provided a parameter extraction system for a touch panel, including: a touch panel including driving electrodes and sensing electrodes that are disposed in a lattice structure; a measuring jig selecting any one of the driving electrodes and selecting any one of the sensing electrodes; a network analyzer measuring S-parameters at cross points at which the driving electrodes and the sensing electrodes selected by the measuring jig cross each other; and a controller converting the S-parameters into Y-parameters, extracting equivalent parameters at the cross points from the Y-parameters, and compensating for a resistance component of the equivalent parameters.

The equivalent parameter may include: mutual capacitance of the driving electrode and the sensing electrode; parasitic capacitance of the driving electrode; parasitic capacitance of the sensing electrode; a resistance component of the driving electrode and the sensing electrode; and inductance of the driving electrode and the sensing electrode.

The measuring jig may include: a first switching unit selecting any one of the driving electrodes; and a second switching unit selecting any one of the sensing electrodes.

The network analyzer may be a 2-port vector network analyzer measuring a phase.

The controller may include: a conversion unit converting the S-parameters at the cross points into the Y-parameters; an extraction unit extracting the equivalent parameters at the cross points from the Y-parameters; a compensation unit performing a loss compensation according to a voltage distribution phenomenon by mutual capacitance of the driving electrode and the sensing electrode and parasitic capacitance of the sensing electrode with respect to the resistance component of the equivalent parameters; and a jig control unit controlling the measuring jig to select any driving electrode and any sensing electrode.

According to another preferred embodiment of the present invention, there is to provided a parameter extraction method for a touch panel, including: (A) performing a calibration of a measuring jig; (B) measuring, by a network analyzer, S-parameters at cross points at which driving electrodes and sensing electrodes of the touch panel selected by the measuring jig cross each other; (C) converting, by a conversion unit of a controller, the S-parameters into Y-parameters; (D) extracting, by an extraction unit of the controller, equivalent parameters from the Y-parameters; and (E) performing, by a compensation unit of the controller, a loss compensation according to a voltage distribution phenomenon by mutual capacitance of the driving electrode and the sensing electrode and parasitic capacitance of the sensing electrode with respect to a resistance component of the equivalent parameters.

The calibration in the step A) may include short, open, load, and thru calibrations.

The network analyzer in the step B) may be a 2-port vector network analyzer measuring a phase.

The equivalent parameter in the step D) may include: mutual capacitance of the driving electrode and the sensing electrode; parasitic capacitance of the driving electrode; parasitic capacitance of the sensing electrode; a resistance component of the driving electrode and the sensing electrode; and inductance of the driving electrode and the sensing electrode.

The parameter extraction method of a touch panel may further include: (F) storing the equivalent parameters extracted in the step D) and the resistance component subjected to the loss compensation by the compensation unit in the step E); and (G) outputting the equivalent parameters and the resistance component subjected to the loss compensation in the step F).

### BRIEF DESCRIPTION OF THE DRAWINGS

The above and other objects, features and advantages of the present invention will be more clearly understood from the following detailed description taken in conjunction to with the accompanying drawings, in which:

FIG. 1 is a block diagram illustrating a parameter extraction system for a touch panel according to a first preferred embodiment of the present invention;

FIG. 2 is an exemplified diagram illustrating driving electrodes and sensing electrodes that are disposed in a lattice structure on the touch panel according to the first preferred embodiment of the present invention;

FIG. 3 is a block diagram illustrating a measuring jig that selects any one of the driving electrodes and the sensing electrodes, respectively, of the touch panel according to the first preferred embodiment of the present invention;

FIG. 4 is a block diagram illustrating in detail a controller according to the first preferred embodiment of the present invention;

FIG. 5 is a circuit diagram illustrating equivalent parameters at cross points according to the first preferred embodiment of the present invention;

FIG. 6 is a flow chart illustrating a parameter extraction method of a touch panel according to a second preferred embodiment of the present invention; and

FIGS. 7A to 7D are exemplified diagrams illustrating a process of performing calibration according to the second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, to when it is determined that the detailed description of the related art would obscure the gist of the present invention, the description thereof will be omitted.

Hereinafter, preferred embodiments of the present invention will be described in detail with reference to the attached drawings.

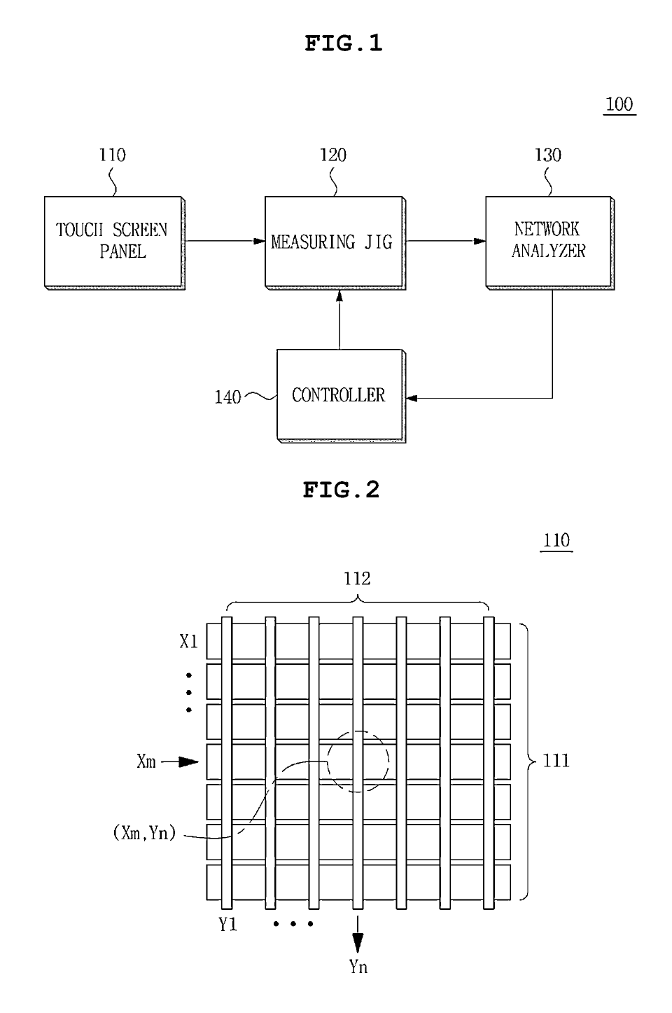

FIG. 1 is a block diagram illustrating a parameter extraction system for a touch panel according to a first preferred embodiment of the present invention.

Referring to FIG. 1, a parameter extraction system 100 for a touch panel according to a first preferred embodiment of the present invention includes a touch panel in which driving electrodes and sensing electrodes are disposed in a lattice structure, a measuring jig that selects any one of the driving electrodes and any one of the sensing electrodes, a network analyzer that measures S-parameters at cross points at which the driving electrode and the sensing electrode selected by the measuring jig cross, and a controller that converts the S-parameters into Y-parameters, extracts equivalent parameters at the cross points from the Y-parameters, and compensates for resistance components of the equivalent parameters.

The parameter extraction system for a touch panel according to the first preferred embodiment of the present invention configured as illustrated in FIG. 1 will be described below in detail.

First, a touch panel 110 senses a position by forming two types of electrode patterns as a mutual capacitive type and forming the one electrode pattern in an X-axis direction and the other in an Y-axis direction to form a lattice structure, and then sequentially measuring capacitance formed at both electrode patterns to calculate coordinates of a contact point.

Herein, both electrodes are a driving electrode 111 that is in charge of driving and a sensing electrode 112 that is in charge of sensing of a touch.

FIG. 2 is an exemplified diagram illustrating driving electrodes and sensing electrodes that are disposed in a lattice structure on the touch panel according to the first preferred embodiment of the present invention.

Referring to FIG. 2, the driving electrodes 111 are arrange in an X axis and the to sensing electrodes 112 are arranged in a Y axis.

FIG. 2 illustrates that the touch panel 110 is configured so that the driving electrodes 111 are arranged in an X-axis direction and the sensing electrodes 113 are arranged in a Y-axis direction. However, axial directions of the driving electrode 111 and the sensing electrode 112 may be set to be switched to each other.

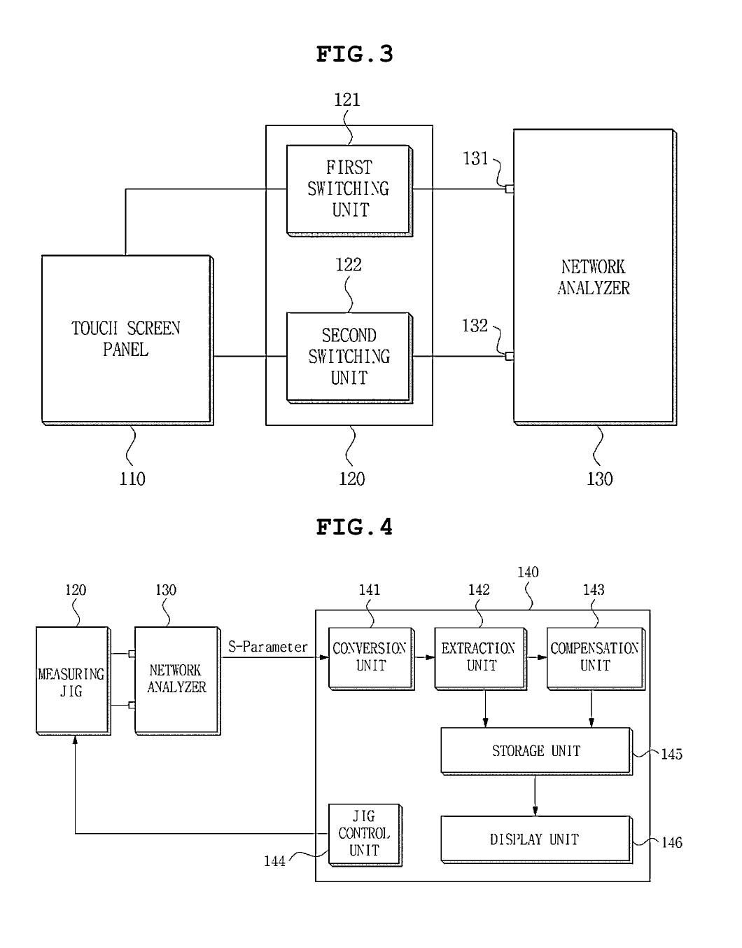

FIG. 3 is a block diagram illustrating a measuring jig that selects any one of the driving electrodes and the sensing electrodes, respectively, of the touch panel according to the first preferred embodiment of the present invention.

Referring to FIG. 3, a first switching unit 121 of the measuring jig 120 selects any driving electrode Xm of the touch panel 110 and a second switching unit 122 thereof selects any sensing electrode Yn.

Further, the first switching unit 121 of the measuring jig 120 is connected to a first port 131 of a network analyzer 130 and the second switching unit 122 is connected with a second port 132 of the network analyzer 130.

Therefore, the network analyzer 130 may measure any cross points Xm and Yn, in particular, the network analyzer 130 measures the S-parameters of any cross points Xm and Yn.

As described above, the network analyzer 130 may measure the S-parameters at all the cross points on the touch panel 110 by measuring any cross points Xm and Yn selected by the measuring jig 120.

In this configuration, when an oscilloscope as a circuit network analyzer indicates a transient response in a time domain and a spectrum analyzer confirms a signal distribution in a frequency domain, since a frequency source and a spectrum analyzer are included in a single machine, the network analyzer 130 is equipment that divides distribution results of a frequency signal of an input and an output by each other to measure the S-parameters.

In particular, the network analyzer 130 may measure S-parameters (magnitude, phase), Reflection & Transmission, Input/Output Impedance, Radiation Pattern, and Timing to Delay.

The network analyzer 130 has two coaxial line connector ports, which are each connected with an input and an output of a device under test (DUT; measuring target). Herein, as the coaxial connector, a small SMA type and a large N type are mainly used. Similar to most of the measuring devices, the network analyzer 130 also supports an interface with a PC and can be linked with software (S/W) of a PC through a general purpose interface bus (GPIB). As a result, automatic measurement and database can be implemented and in particular, this function is usefully used in a device modeling.

In particular, a vector network analyzer that can completely measure even a phase may be used as the network analyzer 130 used in the first preferred embodiment of the present invention.

Next, the controller 140 converts the S-parameters measured by the network analyzer 130 into the Y-parameters.

FIG. 4 is a block diagram illustrating in detail a controller according to the first preferred embodiment of the present invention.

Referring to FIG. 4, the controller 140 according to the first preferred embodiment of the present invention includes a conversion unit 141, an extraction unit 142, a compensation unit 143, a jig control unit 144, a storage unit 145, and a display unit 146.

First, the conversion unit 141 converts the S-parameters at the cross points Xm and Yn into the Y-parameters.

The extraction unit 142 extracts the equivalent parameters at the cross points Xm and Yn from the Y-parameters converted by the conversion unit 141.

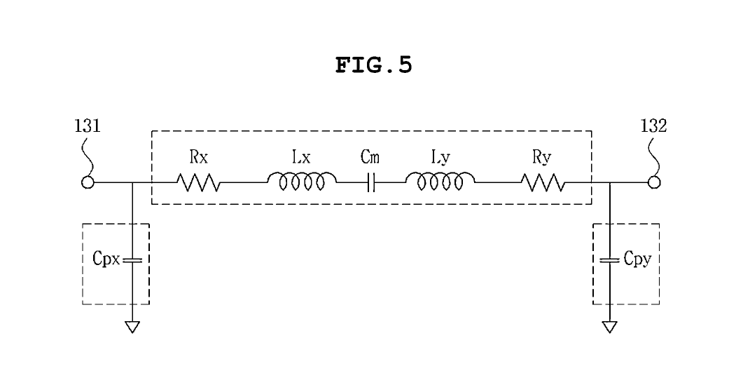

Herein, the equivalent parameters will be described in detail with reference to FIG. 5.

FIG. 5 is a circuit diagram illustrating the equivalent parameters at any cross points according to the first preferred embodiment of the present invention.

Referring to FIG. 5, the equivalent parameters include mutual capacitance Cm of the driving electrode and the sensing electrode, parasitic capacitance Cpx of the driving electrode, parasitic capacitance Cpy of the sensing electrode, resistance component R′ of the driving electrode and the sensing electrode, and inductance L of the driving electrode and the sensing electrode.

The resistance component R′ is a value obtained by summing resistance Rx of the driving electrode and resistance Ry of the sensing electrode and the inductance L is a value obtained by summing inductance Lx of the driving electrode and inductance Ly of the sensing electrode.

Herein, the resistance component R′ generates a voltage distribution phenomenon due to the mutual capacitance Cm of the driving electrode and the sensing electrode and the parasitic capacitance Cpy of the sensing electrode. Therefore, in order to accurately derive the resistance component R, a compensation value according to the voltage distribution phenomenon needs to be applied.

Therefore, the compensation unit 143 illustrated in FIG. 4 applies the compensation value according to the voltage distribution phenomenon to the resistance component R′ to accurately calculate the resistance component R.

As described above, the equivalent parameters extracted from the extraction unit 142 and the resistance component R compensated by the compensation unit are stored in a storage unit 145.

Herein, the storage unit 145 may be various types of recording media that can be electronically read, such as a random access memory (RAM), a flash memory, a read only memory (ROM), an erasable programmable ROM (EPRROM), an electronically erasable and programmable ROM (EEPROM), a register, a hard disk, a removable disk, a memory card, a USB memory, a CD-ROM, and the like, but is not necessarily limited thereto.

As described above, the equivalent parameters stored in the storage unit 145 and the compensated resistance component R are displayed on a screen of a display unit 146.

Herein, as a method for displaying the equivalent parameters and the compensated resistance component on the display unit 146, any method, such as a numerical display, a graph display, and the like, may be used without being particularly limited.

Meanwhile, the jig control unit 144 of the controller 140 controls the first switching unit 121 and the second switching unit 122 so that the measuring jig 120 selects any cross points Xm and Yn.

In particular, the jig control unit 144 may be programmed according to a setting so as to select a part or all of the cross points of the touch panel 110.

As described above, according to the first preferred embodiment of the present invention, the range of the input signal of the touch panel may be accurately measured by accurately extracting the equivalent parameters at any cross points Xm and Yn. An operation range of an analog circuit of the touch panel, a size of an implementation circuit, a determination of circuit timing, and a calibration method of firmware may be accurately determined by accurately measuring the range of the input signal, thereby more efficiently designing the touch panel.

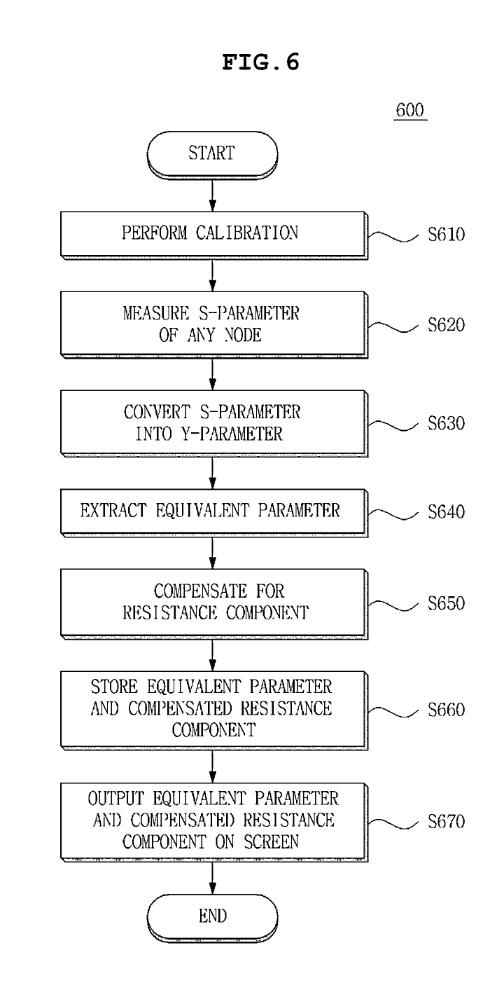

FIG. 6 is a flow chart illustrating a parameter extraction method for a touch panel according to a second preferred embodiment of the present invention.

Referring to FIG. 6, a parameter extraction method 600 for a touch panel according to the second preferred embodiment of the present invention includes performing a calibration of a measuring jig (S610), measuring, by a network analyzer, S-parameters at cross points at which driving electrodes and sensing electrodes of the touch panel selected by the measuring jig cross each other (S620), converting, by a conversion unit of a controller, S-parameters into Y-parameters (S630), extracting, by an extraction unit of the controller, equivalent parameters from the Y-parameters (S640), performing, by a compensation unit of the controller, a loss compensation according to a voltage distribution phenomenon by mutual capacitance of the driving electrodes and the sensing electrodes and parasitic capacitance of the sensing electrodes with respect to the resistance component of the equivalent parameters (S650), storing the equivalent parameters extracted from the S640 to and the resistance component subjected to a loss compensation by the compensation unit in the S650 (S660), and outputting the equivalent parameters and the resistance component subjected to the loss compensation in the S660 on a screen (S670).

The parameter extraction method 600 for a touch panel according to the second preferred embodiment of the present invention configured as illustrated in FIG. 6 will be described below in detail.

First, the calibration of the measuring jig is performed (S610).

Generally, the network analyzer performs the calibration by performing SOLT (short, open, load, thru) on two ports. However, the calibration according to the second preferred embodiment of the present invention is performed at ends of the first switching unit 121 and the second switching unit 122 of the measuring jig 120 that are each connected with the two ports of the network analyzer 130 (S610).

This is to compensate for a loss occurring at the measuring jig 120 between the network analyzer 130 and the touch panel screen 110.

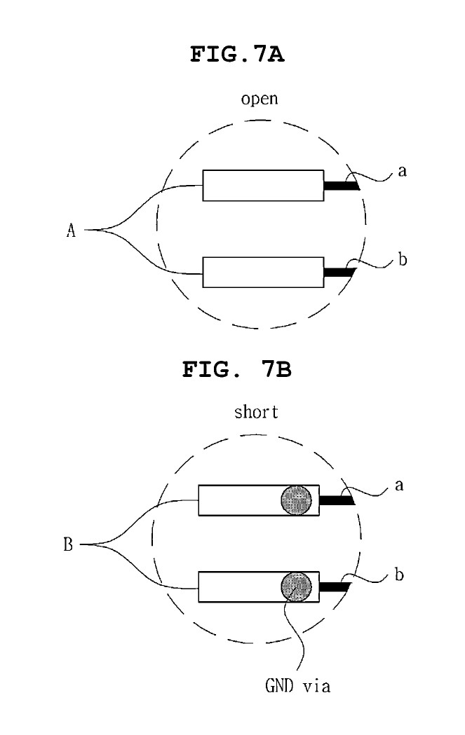

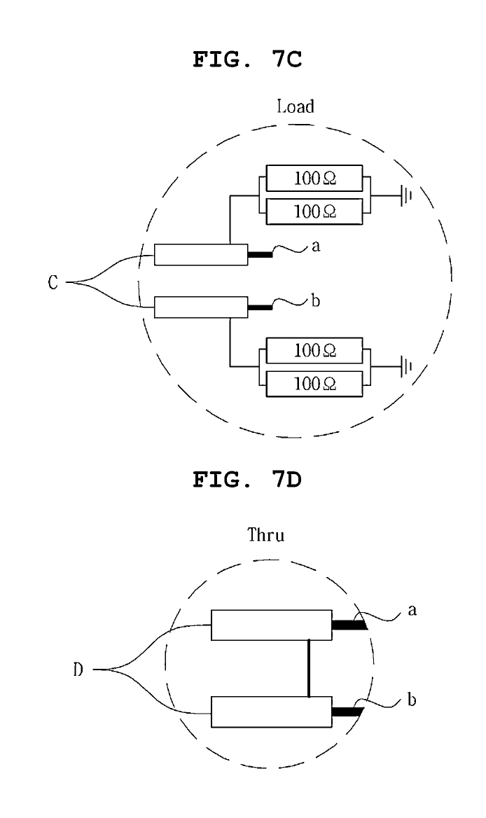

FIGS. 7A to 7D are exemplified diagrams illustrating a process of performing calibration according to the second preferred embodiment of the present invention.

Referring first to FIG. 7A, an open calibration kit A is connected with an end a of a first channel unit 121 that is connected with the driving electrode of the touch panel 110 and an end b of the second channel unit 122 that is connected with the sensing electrode of the touch panel 110, respectively, to measure the measuring signal input and output from the network analyzer 130, thereby performing the open calibration.

Referring to FIG. 7B, a short calibration kit B is connected with the end a of the first channel unit 121 that is connected with the driving electrode of the touch panel 110 and the end b of the second channel unit 122 that is connected with the sensing electrode of the touch panel 110, respectively, to measure the measuring signal input and output to and from the network analyzer 130, thereby performing the short calibration.

Herein, the short calibration kit B may include a ground via GND via.

Referring to FIG. 7C, a load calibration kit C is connected with the end a of the first channel unit 121 that is connected with the driving electrode of the touch panel 110 and the end b of the second channel unit 122 that is connected with the sensing electrode of the touch panel 110, respectively, and connects a resistor of 50Ω to the load calibration kit C to measure the measuring signal input and output to and from the network analyzer 130, thereby performing the load calibration.

Herein, the resistors having 100Ω are preferably connected in parallel. The reason of connecting the resistors of 100Ω in parallel is to more reduce an error of resistance.

Referring to FIG. 7D, a thru calibration kit D is connected with the end a of the first channel unit 121 that is connected with the driving electrode of the touch panel 110 and the end b of the second channel unit 122 that is connected with the sensing electrode of the touch panel 110, respectively, to measure the measuring signal input and output to and from the network analyzer 130, thereby performing the thru calibration.

Here, as the thru calibration kit D, a terminal for minimizing the loss of the measuring signal at the time of connecting the two ends a and b may be used.

As described above, the calibration of the measuring jig is performed (S610), and then the S-parameters of any cross points Xm and Yn at which the driving electrodes and the sensing electrodes of the touch panel 110 selected by the measuring jig 120 cross each other are measured by the network analyzer 130 (S620).

Here, the jig control unit 144 of the controller 140 controls the first switching unit 121 and the second switching unit 122 so that the measuring jig 120 selects any cross points Xm and Yn.

The measured S-parameters are converted into the Y-parameters by the conversion unit 130 (S630).

Here, the conversion unit 130 stores the following Equations 1 to 5 and performs the calculation so that the S-parameters are converted into the Y-parameters based on the following Equations 1 to 5.

$$\begin{matrix}{Y}_{11} = {Y}_{0} \frac{( 1 - {S}_{11} ) ( 1 + {S}_{22} ) + {S}_{12} {S}_{21}}{( 1 + {S}_{11} ) ( 1 + {S}_{22} ) - {S}_{12} {S}_{21}} & [ Equation 1 ] \\ {Y}_{12} = {Y}_{0} \frac{- 2 {S}_{12}}{( 1 + {S}_{11} ) ( 1 + {S}_{22} ) - {S}_{12} {S}_{21}} & [ Equation 2 ] \\ {Y}_{21} = {Y}_{0} \frac{- 2 {S}_{21}}{( 1 + {S}_{11} ) ( 1 + {S}_{22} ) - {S}_{12} {S}_{21}} & [ Equation 3 ] \\ {Y}_{22} = {Y}_{0} \frac{( 1 + {S}_{11} ) ( 1 - {S}_{22} ) + {S}_{12} {S}_{21}}{( 1 + {S}_{11} ) ( 1 + {S}_{22} ) - {S}_{12} {S}_{21}} & [ Equation 4 ] \\ {Y}_{0} = \frac{1}{{Z}_{0}} & [ Equation 5 ]\end{matrix}$$

When the Y-parameters of any cross points Xm and Yn are calculated based on the above Equations 1 to 5, the extraction unit 142 of the controller 140 extracts the equivalent parameters from the Y-parameters (S640).

Herein, referring to FIG. 5, the equivalent parameters include mutual capacitance Cm of the driving electrode and the sensing electrode, parasitic capacitance Cpx of the driving electrode, parasitic capacitance Cpy of the sensing electrode, resistance component R′ of the driving electrode and the sensing electrode, and inductance L of the driving electrode and the sensing electrode.

In more detail, each component of the equivalent parameters is extracted by the extraction unit 142 in which the following Equations 6 to 10 are stored.

$$\begin{matrix}{R}^{′} = Re ( - 1 / {Y}_{12} ) & [ Equation 6 ] \\ Cm = - \frac{1}{2 π f Im ( - 1 / {Y}_{12} )} & [ Equation 7 ] \\ {C}_{px} = \frac{Im ( {Y}_{11} + {Y}_{12} )}{2 π f} & [ Equation 8 ] \\ {C}_{py} = \frac{Im ( {Y}_{22} + {Y}_{12} )}{2 π f} & [ Equation 9 ]\end{matrix}$$

In the above Equations 6 to 9, the resistance component R′ is a value obtained by summing resistance Rx of the driving electrode and resistance Ry of the sensing electrode and the inductance L is a value obtained by summing inductance Lx of the driving electrode and inductance Ly of the sensing electrode.

Meanwhile, the resistance component R′ generates a voltage distribution phenomenon due to the mutual capacitance Cm of the driving electrode and the sensing electrode and the parasitic capacitance Cpy of the sensing electrode. Therefore, in order to accurately derive the resistance component R, a compensation value according to the voltage distribution phenomenon needs to be applied.

For this reason, the compensation unit 143 of the controller 140 performs the loss compensation according to the voltage distribution phenomenon by the mutual capacitance Cm of the driving electrode and the sensing electrode and the parasitic capacitance Cpy of the sensing electrode with respect to the resistance component R′ of the equivalent parameters (S650).

To this end, the compensation unit 143 stores the following Equation 10 and may obtain the accurate value of the resistance component R based on the following Equation 10.

$$R = {R}^{′} ( \frac{{C}_{m}}{{C}_{m} + {C}_{py}} ) \qquad [ Equation 10 ]$$

As such, the extracted equivalent parameters and the accurate value of the resistance component R are stored in the storage unit 145 (S650).

Herein, the storage unit 145 may be various types of recording media that can be electronically read, such as a random access memory (RAM), a flash memory, a read only memory (ROM), an erasable programmable ROM (EPRROM), an electronically erasable and programmable ROM (EEPROM), a register, a hard disk, a removable disk, a memory card, a USB memory, a CD-ROM, and the like, but is not necessarily limited thereto.

Finally, the equivalent parameters and the accurate value of the resistance component R that are stored in the storage unit 145 are output on the screen of the display unit 146.

Here, as the method for outputting the equivalent parameters and the accurate value of the resistance component R on the display unit 146, any method, such as a numerical display, a graph display, and the like, may be used without being particularly limited.

As described above, the range of the input signal of the touch panel may be accurately measured by accurately extracting the equivalent parameters of any cross points Xm and Yn of the electrodes of the touch panel 110. As described above, the operation range of the analog circuit of the touch panel, the components, the size of the implementation circuit, the determination of circuit timing, and the calibration method of firmware may be accurately determined by accurately measuring the range of the input signal, thereby more efficiently designing the touch panel.

According to various preferred embodiments of the present invention, it is possible to improve the response speed at the time of designing the touch panel by extracting all the equivalent parameters of the touch panel.

Further, according to various preferred embodiments of the present invention, it is possible to improve the power efficiency of the touch panel by accurately measuring the electrical characteristics of the touch panel.

In addition, according to various preferred embodiments of the present invention, it is possible to effectively designing the touch panel by accurately measuring the electrical characteristics of the touch panel.

Due to the foregoing effects, according to various exemplary embodiments of the present invention, it is possible to contribute to the stability of processes and the improvement in quality at the time of production of the touch panel.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A parameter extraction system for a touch panel, comprising:
a touch panel including driving electrodes and sensing electrodes that are disposed in a lattice structure;
a measuring jig selecting any one of the driving electrodes and selecting any one of the sensing electrodes;
a network analyzer measuring S-parameters at cross points at which the driving electrodes and the sensing electrodes selected by the measuring jig cross each other; and
to a controller converting the S-parameters into Y-parameters, extracting equivalent parameters at the cross points from the Y-parameters, and compensating for a resistance component of the equivalent parameters.

2. The parameter extraction system as set forth in claim 1, wherein the equivalent parameter includes:
mutual capacitance of the driving electrode and the sensing electrode;
parasitic capacitance of the driving electrode;
parasitic capacitance of the sensing electrode;
a resistance component of the driving electrode and the sensing electrode; and
inductance of the driving electrode and the sensing electrode.

3. The parameter extraction system as set forth in claim 1, wherein the measuring jig includes:
a first switching unit selecting any one of the driving electrodes; and
a second switching unit selecting any one of the sensing electrodes.

4. The parameter extraction system as set forth in claim 1, wherein the network analyzer is a 2-port vector network analyzer measuring a phase.

5. The parameter extraction system as set forth in claim 1, wherein the controller includes:
a conversion unit converting the S-parameters at the cross points into the Y-parameters;
an extraction unit extracting the equivalent parameters at the cross points from the Y-parameters;
a compensation unit performing a loss compensation according to a voltage distribution phenomenon by mutual capacitance of the driving electrode and the sensing electrode and parasitic capacitance of the sensing electrode with respect to the resistance component of the equivalent parameters; and
a jig control unit controlling the measuring jig to select any driving electrode and any sensing electrode.

6. The parameter extraction system as set forth in claim 5, wherein the controller further includes:
a storage unit in which the equivalent parameters and the resistance component to which the compensation of the compensation unit is applied are stored; and
a display unit outputting the equivalent parameters and the resistance component subjected to the loss compensation on a screen thereof.

7. A parameter extraction method for a touch panel, comprising:
(A) performing a calibration of a measuring jig;
(B) measuring, by a network analyzer, S-parameters at cross points at which driving electrodes and sensing electrodes of the touch panel selected by the measuring jig cross each other;
(C) converting, by a conversion unit of a controller, the S-parameters into Y-parameters;
(D) extracting, by an extraction unit of the controller, equivalent parameters from the Y-parameters; and
(E) performing, by a compensation unit of the controller, a loss compensation according to a voltage distribution phenomenon by mutual capacitance of the driving electrode and the sensing electrode and parasitic capacitance of the sensing electrode with respect to a resistance component of the equivalent parameters.

8. The parameter extraction method as set forth in claim 7, wherein the calibration in the step A) includes short, open, load, and thru calibrations.

9. The parameter extraction method as set forth in claim 7, wherein the network analyzer in the step B) is a 2-port vector network analyzer measuring a phase.

10. The parameter extraction method as set forth in claim 7, wherein the equivalent parameter in the step D) includes:
mutual capacitance of the driving electrode and the sensing electrode;
parasitic capacitance of the driving electrode;
parasitic capacitance of the sensing electrode;
a resistance component of the driving electrode and the sensing electrode; and
inductance of the driving electrode and the sensing electrode.

11. The parameter extraction method as set forth in claim 7, further comprising:
(F) storing the equivalent parameters extracted in the step D) and the resistance component subjected to the loss compensation by the compensation unit in the step E); and
(G) outputting the equivalent parameters and the resistance component subjected to the loss compensation in the step F).
